(19) United States
(12) Patent Application Publication
(10) Pub. No.: US 2012/0285391 A1
(43) Pub. Date: Nov. 15, 2012

(54) Dog's Waste Holder

(76) Inventor: RAFAEL ALARCON, PASADENA, CA (US)

(21) Appl. No.: 13/429,953

(22) Filed: Mar. 26, 2012

Related U.S. Application Data
(60) Provisional application No. 61/486,248, filed on May 14, 2011.

(51) Int. Cl. A01K 29/00; B29C 65/00

(52) U.S. Cl. 119/161; 156/297

(57) ABSTRACT

The dog's waste holder is an original and first product that collects the dog's waste before it is fall into the ground, making possible its later disposal in a clean and comfortable way.

### CROSS-REFERENCE

Provisional Application No. 61/486,248

### DESCRIPTION

The dog's waste holder is a cone basket made with wire and cloth, which is set around the dog's anus by belts and a cape. When the dog poops, the waste falls into the plastic-lined basket , and it is held there until it is removal and disposal later.

### USEFULNESS

The dog's waste holder prevents the fall of a dog's feces onto the ground. Consequently the dog's owner can clean after the dog without having to pick up the dog's waste from the ground. Collection and disposal of the dog's feces can be done more comfortably and at a later time. With this device the sidewalks, yards, parks, beaches and other places where dogs walk will be left cleaner. This device will be especially pleasing to residents who resent dog waste on their property.

### BACKGROUND OF THE INVENTION

To my knowledge there is no background information on a Dog's Waste Holder. At the present time, dog waste falls to the ground and the dog's owners have a responsibility to pick up the feces and dispose of it.

### BRIEF SUMMARY OF THE INVENTION

With the Dog's Waste Holder, the dog's feces are held in a container before it falls to the ground and stays there, until the dog's owner removes and disposes of it.

### ADVANTAGES OF THE DOG'S WASTE HOLDER

The dog's owner does not need to be watching the dog all the time to see if it poops or not.

The dog's owner does not need to bend over to pick up the dog's feces form the ground.

Disposal of feces becomes a more sanitary, thorough and comfortable task.

Dog owners no longer have to experience the “feel” of dog waste on their hands, eliminating what for some is a nasty feeling.

Cleanup of feces is easy regardless of its consistency.

There is not need to clean up after the dog's feces immediately.

### DETAILED DESCRIPTION OF THE DOG'S WASTE HOLDER

The dog's waste holder is an article that is set around the dog's anus, with the purpose of catching and carrying the dog's feces, preventing the feces from falling to the ground.

### Process of Making

The dog's waste holder is made in three processes:
The three rings
The basket
The cloak

The 3 rings are made with galvanized wire, which is twisted and then covered with a polypropylene band. The form of the ring holder is used to hold four strips that keep the basket on it place. At the same time the ring base is use as a frame that allows the ring basket to open and close. The ring basket is set to the ring base with a spring that keep the basket closed, but easily opened.

The basket is made of fabric in the form of a cone. The opening of the cone is sown with Velcro and used to affix it to the basket ring.

The cloak is made of fabric and covers the dog's back. The cloak has two plastic rods to reinforce the cloth and hold it in place. The cloak is fixed to the dog by three polypropylene bands: one at the dog's neck, other at he dog's chest, and the third around the dog's stomach.

### How to Use

The dog's waste holder is affixed to the dog by first inserting the tail into the ring holder, and then fastening the belts. A plastic bag is place into the basket and now the device is ready to be used. A dog wearing the waste holder can be walking at any place or time and it waste will drop into the plastic bag. At the owner's convenience, he or she can remove the plastic bag of dog waste and dispose of it. To reuse the dog's waste holder merely place a new plastic bag into the holder.

1. Any container with the purpose of holding dogs' waste in order to prevent it from falling onto the ground.

2. An article that includes the step of adhesively to bonding parts together.

3. The mechanical joining that allows the easy closing and opening of the basket.

4. The process of manufacturing the dog's waste holder, including assembling.
